(19) United States
(12) Patent Application Publication
(10) Pub. No.: US 2026/0301290 A1
(43) Pub. Date: Oct. 1, 2026

(54) CONTROL SYSTEM, CONTROL METHOD, AND RECORDING MEDIUM

(71) Applicant: NEC Corporation, Tokyo (JP)

(72) Inventors: Yuki TSURUOKA, Tokyo (JP); Yushi NIWA, Tokyo (JP); Akihiko ONITA, Tokyo (JP); Takashi MIYAKE, Tokyo (JP)

(73) Assignee: NEC Corporation, Tokyo (JP)

(21) Appl. No.: 19/479,397

(22) PCT Filed: Jun. 12, 2023
(86) PCT No.: PCT/JP2023/021722

§ 371 Date: Oct. 28, 2025

(51) Int. Cl. G06T 13/40; G06F 3/01; G06Q 30/015; G06T 11/60; G06T 13/80

(52) U.S. Cl. CPC G06T 13/40; G06F 3/011; G06Q 30/015; G06T 11/60; G06T 13/80; G06F 2203/011

(57) ABSTRACT

A control system includes: one or more memories storing instructions; and one or more processors configured to execute the instructions to: output an avatar of a provider who provides a service to a user of the service in a virtual reality space and an action of the avatar to a display device of the user; acquire an action history of the user who is using the service; determine at least one of the avatar of the provider of the service and the action of the avatar in the virtual reality space, based on the action history of the user; and switch at least one of the avatar and the action of the provider of the service to at least one of the determined avatar and action of the provider and outputs at least one of the determined avatar and action.

### TECHNICAL FIELD

The present disclosure relates to a control system or the like.

### BACKGROUND ART

It is known to provide services such as a customer service and a lecture in a virtual reality space. It is known that an avatar of a user can be set in the virtual reality space. For example, PTL 1 describes that an avatar is created based on a feature such as a height of a user.

For example, PTL 2 describes that a virtual clerk to be an interaction partner of a customer is selected before starting shopping and the selected virtual clerk serves the customer during shopping.

### CITATION LIST

### Patent Literature

PTL 1: JP 2022-117770 A

PTL 2: JP 2020-160641 A

### SUMMARY OF INVENTION

### Technical Problem

In general, when a user uses various services, an action of the user may change depending on a provider. In such a case, there is a case where it is difficult for the user of the service to use the service in a virtual reality space.

An example of objects of the present disclosure is to provide a control system or the like that enables to facilitate use of a service by a user of the service in a virtual reality space.

### Solution to Problem

A control system according to one aspect of the present disclosure includes output means for outputting an avatar of a provider who provides a service to a user of the service in a virtual reality space and an action of the avatar to a display device of the user, acquisition means for acquiring an action history of the user who is using the service, and determination means for determining at least one of the avatar of the provider of the service and the action of the avatar in the virtual reality space, based on the action history of the user, in which the output means switches at least one of the avatar and the action of the provider of the service to at least one of the determined avatar and action of the provider and outputs at least one of the determined avatar and action.

A control method according to one aspect of the present disclosure in which a computer performs processing including outputting an avatar of a provider who provides a service to a user of the service in a virtual reality space and an action of the avatar to a display device of the user, acquiring an action history of the user who is using the service, and determining at least one of the avatar of the provider of the service and the action of the avatar in the virtual reality space, based on the action history of the user, in which, in the outputting processing, at least one of the avatar and the action of the provider of the service is switched to at least one of the determined avatar and action of the provider, and at least one of the determined avatar and action is output.

A program according to one aspect of the present disclosure causes a computer to execute processing including outputting an avatar of a provider who provides a service to a user of the service in a virtual reality space and an action of the avatar to a display device of the user, acquiring an action history of the user who is using the service, and determining at least one of the avatar of the provider of the service and the action of the avatar in the virtual reality space, based on the action history of the user, in which, in the outputting processing, at least one of the avatar and the action of the provider of the service is switched to at least one of the determined avatar and action of the provider, and at least one of the determined avatar and action is output.

Each program may be stored in a non-transitory computer-readable recording medium.

### Advantageous Effects of Invention

According to the present disclosure, it is possible to facilitate use of a service by a user of the service in a virtual reality space.

### BRIEF DESCRIPTION OF DRAWINGS FIG. 1 is a first block diagram illustrating a configuration example of a control system according to the present disclosure.

FIG. 2 is a flowchart illustrating an operation example of the control system.

FIG. 3 is an explanatory diagram illustrating an example of connection between the control system and another device.

FIG. 4 is an explanatory diagram illustrating an example 1 of a display device.

FIG. 5 is an explanatory diagram illustrating an example 2 of the display device.

FIG. 6 is a second block diagram illustrating a configuration example of the control system according to the present disclosure.

FIG. 7 is an explanatory diagram illustrating an example of determining a new avatar by a learning model.

FIG. 8 is an explanatory diagram (part 1) illustrating an example of a screen for receiving an instruction.

FIG. 9 is an explanatory diagram (part 2) illustrating an example of receiving the instruction.

FIG. 10 is an explanatory diagram illustrating an output example of a determined number of patients.

FIG. 11 is a flowchart illustrating an operation example of the control system that switches at least one of an avatar or an action of a user.

FIG. 12 is a flowchart illustrating an operation example of the control system that switches at least one of an avatar or an action of a provider.

FIG. 13 is an explanatory diagram illustrating a hardware configuration example of a computer.

### EXAMPLE EMBODIMENT

Hereinafter, example embodiments of a control system, a control method, a program, and a non-transitory recording medium recording the program according to the present disclosure will be described in detail with reference to the drawings. The present example embodiment does not limit the disclosed technology.

### First Example Embodiment

First, in a first example embodiment, an example of a basic function of a control system will be described. FIG. 1 is a first block diagram illustrating a configuration example of the control system according to the present disclosure. A control system 10 includes an output unit 101, an acquisition unit 102, and a determination unit 103.

First, the output unit 101 outputs an avatar of a provider who provides a service to a user of the service in a Virtual Reality (VR) space and an action of the avatar to a display device of the user. The service is a customer service, practice, classes, lectures, counseling, or the like and is not particularly limited. The customer service may be a customer service at the time of shopping for selling a product and is not particularly limited.

The avatar here includes at least one of a face, clothes, a gender, a hairstyle, accessories, an atmosphere, or the like. The atmosphere of the avatar may be an expression, an age atmosphere, or the like. The action of the avatar includes at least one of a gesture or a hand gesture of the avatar, a speaking speed of the avatar, voice of the avatar, a volume of the voice of the avatar, a motional motion of the avatar, or the like. The motional motion may be a motion in sports practice or the like.

For example, if the service is the customer service, the user is a customer, and the provider is a clerk. For example, if the service is the practice, the class, or the like, the user is a student, and the provider is a teacher. For example, if the service is the counseling, the user is a consulter, and the provider is a counselor. For example, if the service is counseling by a doctor, the user is a patient, and the counselor is a doctor.

The acquisition unit 102 acquires an action history of the user who is using the service. The action history of the user who is using the service may include voice information of the user in a conversation with the provider. The voice information may be a degree of attentive listening of the user in the conversation with the provider. For example, the voice information may be a volume of voice or the like. The action history of the user who is using the service may include information regarding an image actually viewed by the user in the virtual reality space. The action history may include biometric information of the user. The biometric information may include, for example, heart rate information, body temperature information, blood pressure information, perspiration information, and information regarding eyes.

Here, the action history of the user is acquired via a device such as a wearable device attached to an actual user or a device such as an imaging device that can image the user or a sound collection device that can collect sound such as voice. For example, the biometric information can be acquired via the wearable device, the imaging device, or the like. For example, the body temperature information, the information regarding the eyes, the perspiration information, or the like may be specified from an image imaged by the imaging device. The heart rate information, the body temperature information, the blood pressure information, and the perspiration information may be acquired by the wearable device. The voice information can be acquired via the sound collection device or the like. In a case where the display device is a Head Mounted Display (HMD), the action history may be acquired via the HMD worn by the user. For example, if the display device is the HMD, the acquisition unit 102 can acquire the information regarding the eyes of the user or the like, as the action history. Here, as the information regarding the eyes, perspective information indicating a perspective of the user, information regarding whether the eyes of the user are open/closed, information regarding blinking of the user, and the like are exemplified.

The determination unit 103 determines at least one of the avatar of the provider of the service and the action of the avatar in the VR space, based on the action history of the user who is using the service. Here, the provider of the service for which the determination unit 103 determines the avatar or the action may be a provider different from the provider who is providing the service to the user or may be the provider who is providing the service to the user.

For a method for determining the avatar of the provider of the service and the action of the avatar by the determination unit 103, a table prepared in advance may be used, and a learned model prepared in advance may be used.

First, a case where the table is used will be described as an example. For example, a table may be prepared in which the action history of the user and the avatar of the provider are associated with each other in advance. The determination unit 103 may determine an avatar associated with the action history of the user acquired by the acquisition unit 102, from the table, as the avatar of the provider. For example, a table may be prepared in which the action history of the user and the action of the avatar of the provider are associated with each other in advance. The determination unit 103 may determine an action of the avatar associated with the action history of the user acquired by the acquisition unit 102, from the table, as the action of the avatar of the provider.

Next, a case where the learned model is used will be described as an example. The model is, for example, a model that has learned a relationship between the action history of the user and the avatar of the provider and the action of the avatar, based on past action histories of a plurality of users and an avatar of the provider and an action of the avatar at the time when each of the plurality of users uses the service. The model may be, for example, a model that has learned a relationship between the action history of the user and changes in the avatar of the provider and the action of the avatar, based on the past action histories of the plurality of users and the avatar of the provider and the action of the avatar at the time when each of the plurality of users uses the service.

For example, the determination unit 103 inputs the action history of the user acquired by the acquisition unit 102, into the model learned in advance, and determines at least one of the avatar and the action of the provider of the service.

Next, more specifically, for example, a guideline for the determination unit 103 to determine at least one of the avatar of the provider of the service and the action of the avatar in the VR space, based on the action history will be described.

First, a degree of attentive listening of the user obtained from the voice information will be described as an example. For example, in a case where the degree of attentive listening of the user obtained from the voice information is high, there is a high possibility that the user is highly interested in the conversation with the provider. On the other hand, in a case where the degree of attentive listening of the user is low, there is a high possibility that the user is less interested in the conversation with the provider. Therefore, for example, the determination unit 103 may determine whether to change the avatar of the provider and the action of the avatar, according to the degree of attentive listening of the user. It is sufficient to use a threshold such as a predetermined degree, a predetermined range, or the like to determine a level of the degree of attentive listening, which is not particularly limited. For example, in a case where the degree of attentive listening of the user is high, the determination unit 103 may determine not to change the avatar of the provider and the action of the avatar. For example, in a case where the degree of attentive listening of the user is low, the determination unit 103 may determine at least one of the avatar of the provider and the action of the avatar. For example, in a case where the degree of attentive listening is low, the determination unit 103 may determine the avatar to be another provider. As a result, for example, a change in the degree of attentive listening in a case where the avatar is changed can be found. For example, in a case where the service is the customer service, in a case where the degree of attentive listening of the user is low, the determination unit 103 may determine the action of the avatar of the provider in such a way as to change explanation content of a product or may determine the action of the avatar of the provider in such a way as to change a recommended product. For example, in a case where the service is the counseling, in a case where the degree of attentive listening of the user is low, the determination unit 103 may determine the action of the avatar of the provider in such a way as to change a question.

A word uttered by the user will be described as an example. For example, the determination unit 103 may determine the avatar of the provider and the action of the avatar, depending on whether the user utters many words registered in a negative word list, based on the voice information of the user. For example, in a case where the user utters many words registered in the negative word list, the determination unit 103 may determine the action of the avatar of the provider in such a way as to cause the avatar of the provider to utter more words registered in a positive word list. The negative word list is, for example, a list of words representing negative meanings. The positive word list is, for example, a list of words representing positive meanings. For example, in a case where the user utters many words registered in the negative word list, the determination unit 103 may determine the action of the avatar of the provider in such a way as to cause the avatar of the provider to utter more words that empathize with the user. As an example of using the learned model as described above, the determination unit 103 acquires the avatar of the provider and the action of the avatar, from the learned model, by inputting the word, registered in the negative word list, uttered by the user, into the learned model. For example, the model is a model that has learned a relationship between a word uttered by the user and the avatar of the provider and the action of the avatar, based on a word, registered in the negative word list, uttered by each of the plurality of users in the past and the avatar of the provider and the action of the avatar at the time when each of the plurality of users uses the service. The model may be a model that has learned a relationship between the words uttered by the user and the changes in the avatar of the provider and the action of the avatar.

For example, the determination unit 103 may determine the avatar of the provider and the action of the avatar, depending on whether the user utters many words registered in the positive word list, based on the voice information of the user.

For example, in a case where the user repeatedly speaks the same noun keyword, there is a high possibility that the user is highly interested in the conversation with the provider. Therefore, for example, the determination unit 103 may determine whether to change the avatar of the provider and the action of the avatar, depending on whether the user utters the same word a predetermined number of times or more. For example, if the user utters the same word the predetermined times or more, the determination unit 103 may determine not to change the avatar of the provider and the action of the avatar. Alternatively, for example, in a case where the user does not utter the same word the predetermined number of times or more, the determination unit 103 may determine to change the avatar of the provider and the action of the avatar.

For example, in a case where a keyword other than a noun is repeatedly spoken, based on the voice information of the user, the determination unit 103 may estimate a positive degree or a negative degree of the user with respect to the conversation with the provider. Then, the determination unit 103 may determine whether to change the avatar of the provider and the action of the avatar, depending on at least one of the positive degree and the negative degree. When the positive degree is taken as an example, in a case where the positive degree is high, the determination unit 103 may determine not to change the avatar of the provider and the action of the avatar. Alternatively, for example, in a case where the positive degree is low, the determination unit 103 may determine to change the avatar of the provider and the action of the avatar.

In a case where the user asks questions many times, there is a high possibility that the user is highly interested in the conversation with the provider. Specifically, for example, in a case where the service is the customer service, in a case where there are many questions about a product explained by the provider, there is a possibility that interest in the product is high. Therefore, the determination unit 103 may determine whether to change the avatar of the provider and the action of the avatar, based on the number of times of questions of the user obtained from the voice information of the user. For example, if the user asks questions a predetermined times or more, the determination unit 103 may determine not to change the avatar of the provider and the action of the avatar. In particular, for example, if the user asks questions about the product the predetermined number of times of more, the determination unit 103 may determine not to change the avatar of the provider and the action of the avatar.

For example, the determination unit 103 may determine the avatar of the provider and the action of the avatar, based on tone of voice of the user specified by the voice information of the user. For example, as the tone of voice of the user, emotions, a tension degree, a fatigue degree, or the like can be estimated.

As one type of the emotions of the user, a domineering attitude, an overbearing attitude, or the like can be estimated. Here, a case where the user has a domineering attitude will be described as an example. For example, if the user has the domineering attitude, the determination unit 103 may determine an avatar in such a way that an age of the avatar of the provider becomes higher than an age of the avatar currently displayed.

For example, if the user has the domineering attitude, the determination unit 103 may determine the avatar of the provider in such a way that the age of the avatar of the provider becomes higher than at least one of an age of the user and an age of the avatar of the user.

Next, the tension degree of the user estimated from the tone of voice of the user will be described as an example. For example, in a case where the tension degree is high, there is a possibility that the user considers that it is difficult to have a conversation with the provider. Therefore, in a case where the tension degree of the user is high, the determination unit 103 determines the avatar and the action of the avatar that lower the tension degree. Specifically, for example, in a case where the tension degree of the user is high, the determination unit 103 may change a gender of the avatar of the provider from a gender of the avatar of the provider who is currently providing the service. For example, in a case where the tension degree of the user is high, the determination unit 103 may lower the age of the avatar of the provider, from an age of the avatar of the provider who is currently providing the service. For example, in a case where the tension degree of the user is high, the determination unit 103 may change the age of the avatar of the provider to be closer to the age of the user. The age of the user may be an age of the user registered in advance or may be an age estimated from the avatar of the user or the action history.

Next, the fatigue degree of the user estimated from the tone of voice of the user will be described as an example. For example, in a case where the fatigue degree of the user is high, there is a possibility that the user desires to use the service in a short time. Therefore, in a case where the fatigue degree of the user is high, the determination unit 103 may determine the action of the avatar in such a way that an utterance such as explanation of the provider becomes shorter, as the action of the avatar of the provider. Alternatively, in a case where the fatigue degree of the user is low, the determination unit 103 may determine the action of the avatar in such a way that the utterance such as the explanation of the provider becomes longer, as the action of the avatar of the provider. If the service is the customer service, the explanation of the provider is, for example, explanation of a product or the like.

For example, since the user is silent based on utterance information of the user, the determination unit 103 may determine the action of the avatar of the provider in such a way as to increase the number of questions for the user. For example, since a time during which the user is talking is long, the determination unit 103 may determine the action of the avatar of the provider in such a way that the utterance of the avatar of the provider increases. For example, whether the time during which the user is talking is long or short and whether the user is silent may be determined by comparing an utterance time of the user and a threshold. For example, whether the time during which the user is talking is long or short and whether the user is silent may be determined by relatively comparing an utterance time of the provider and the utterance time of the user.

The degree of attentive listening, the emotions, the tension degree, the fatigue degree, the interest degree, and the like estimated from the utterance information included in the action history have been described above as examples. The degree of attentive listening, the emotions, the tension degree, the fatigue degree, the interest degree, and the like may be estimated from the biometric information such as at least one of the heart rate information, the body temperature information, the blood pressure information, the perspiration information, and the information regarding the eyes included in the action history.

For example, the determination unit 103 may estimate the emotion, the tension degree, and the fatigue degree, based on at least one of a blood pressure and a change in the blood pressure of the user indicated by the blood pressure information. For example, in a case where the blood pressure suddenly increases, it is estimated that the user is irritated or the tension degree is high. For example, in a case where the blood pressure does not change, it is estimated that the tension degree is low. For example, in a case where a perspiration degree indicated by the perspiration information is high, it is estimated that the user is irritated or the tension degree is high. For example, in a case where the perspiration degree is low, it is estimated that the tension degree is low.

For example, the determination unit 103 may estimate the emotion, the tension degree, and the fatigue degree, based on the information regarding the eyes. More specifically, for example, the determination unit 103 may estimate the interest in the conversation with the provider or the like, based on the information regarding the eyes. If the user looks at a direction not related to the provider, there is a possibility that the user is not interested in the conversation with the provider. For example, if the service is the customer service, user's interest in the product may be estimated based on a line-of-sight of the user. For example, the determination unit 103 may estimate that the tension degree with respect to the provider is high, if the user does not look at the provider, based on the information regarding the eyes. It is sufficient to estimate whether the user looks at the provider, based on a direction of the line-of-sight of the user and a time when the line-of-sight is directed. Alternatively, whether the user looks at the provider may be estimated based on whether the user's eyes are open.

Since an example in which the determination unit 103 determines at least one of the avatar and the action of the avatar and determines whether to change the avatar and the action of the avatar, based on the emotion, the tension degree, the fatigue degree, and the interest degree estimated from the biometric information may be the same as the example using the voice information, detailed description is omitted.

The output unit 101 switches at least one of the avatar and the action of the provider of the service to at least one of the determined avatar and action of the provider and outputs at least one of the determined avatar and action. In a case where the provider of the service of which at least one of the avatar and the action is determined by the determination unit 103 is different from the provider who is currently providing the service to the user, the output unit 101 may output an additionally determined avatar of the provider, while displaying the avatar of the provider who is currently providing the service.

### Flowchart

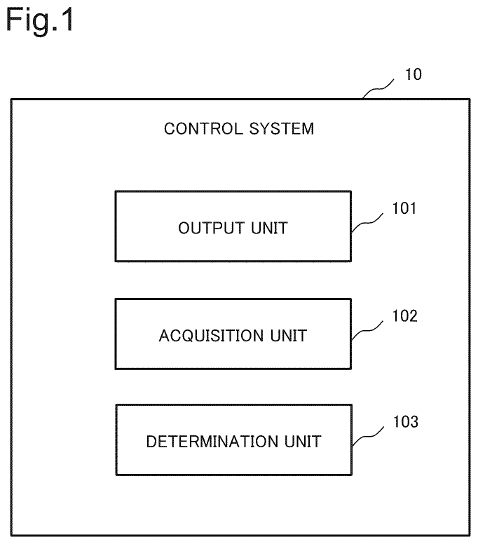

FIG. 2 is a flowchart illustrating an operation example of the control system 10. The output unit 101 outputs the avatar of the provider and the action of the avatar (step S101). The acquisition unit 102 acquires the action history of the user who is using the service (step S102).

The determination unit 103 determines at least one of the avatar of the provider of the service and the action of the avatar, based on the action history (step S103). The output unit 101 performs switching to and outputs at least one of the determined avatar and action of the provider (step S104). The control system 10 may return to step S102 after step $104 and repeat from step S102 to step S104, or the control system 10 may end the processing after step S104.

As described above, in the first example embodiment, the control system 10 outputs the avatar of the provider and the action of the avatar to the user of the service in the VR space and determines at least one of the avatar of the provider of the service and the action of the avatar in the VR space, based on the action history of the user who is using the service. Then, the control system 10 switches at least one of the avatar and the action of the provider of the service to at least one of the determined avatar and action of the provider and outputs at least one of the determined avatar and action.

Use of the service by the user of the service is facilitated. For example, the user is facilitated to perform an action according to an intention of the service of the provider. In addition, provision of the service by the provider is facilitated.

### Second Example Embodiment

Next, a second example embodiment will be described in detail with reference to the drawings. In the second example embodiment, an example in which an avatar of a provider and an action of the avatar are determined will be described in more detail, by exemplifying product sales in a store and counseling by a doctor, as services. In the second example embodiment, an example will be described in more detail in which output is switched. In the second example embodiment, an example of a timing when the output is switched will be described.

Hereinafter, description of content overlapping with the above description will be omitted to the extent that the description of the second example embodiment is not unclear.

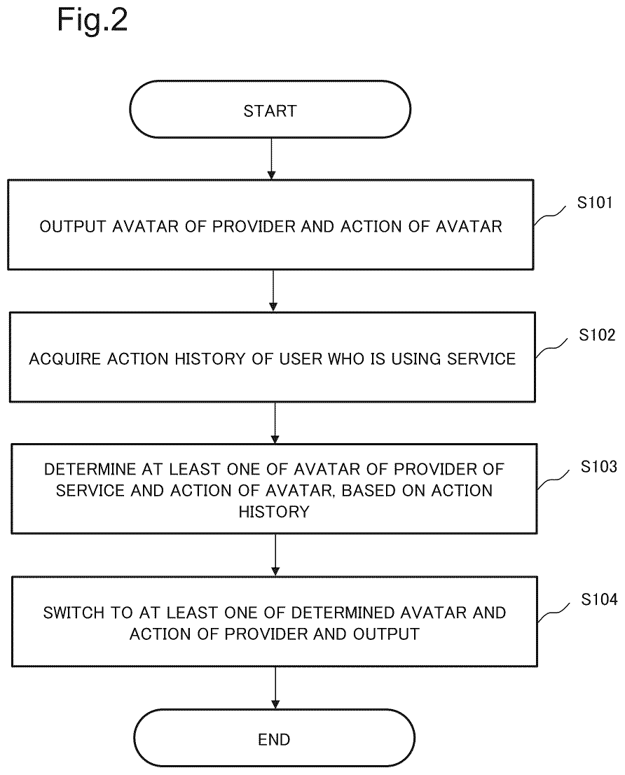

FIG. 3 is an explanatory diagram illustrating an example of connection between a control system and another device. For example, a control system 20 is connected to a display device 21, via a communication network. The display device 21 is, for example, a display device of a user or a display device of the provider. It is sufficient that the number of display devices 21 be determined depending on the number of actual users or actual providers, and is not particularly limited.

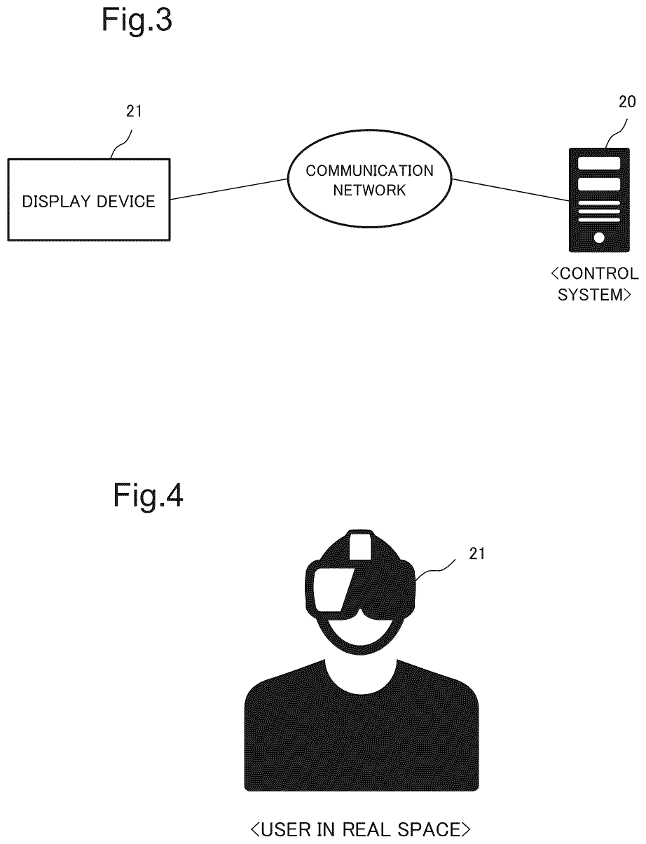

FIG. 4 is an explanatory diagram illustrating an example 1 of the display device 21. In FIG. 4, the display device 21 is an HMD. The HMD which is the display device 21 may have various functions for acquiring an action history or the like. For example, as the function of the HMD, a function of measuring a nod or the like of the user, a function of recording voice, a function of being capable of tracking a motion of an eye such as a line-of-sight or blinking of the user, or a function of being capable of measuring biometric information such as a body temperature may be included. Although the user has been described as an example, the same applies to the provider.

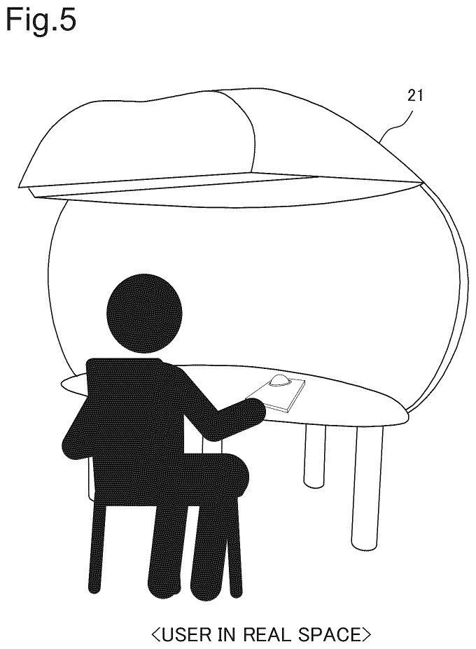

FIG. 5 is an explanatory diagram illustrating an example 2 of the display device 21. In FIG. 5, the display device 21 may be a dome-shaped display. Here, in a case where the dome-shaped display is used as the display device 21, the control system 20 may display an image of an actual user imaged in real time. Therefore, when displaying the avatar, the control system 20 synthesizes an image of the avatar with the image of the actual user, as preprocessing. Then, the control system 20 displays the avatar in such a way as to follow a motion of the actual user. An image of the avatar is generated and displayed in such a way that, the avatar raises a hand when the actual user raises a hand. The motion of the user is a motion of a body such as a face, a head, or a hand of the user. Then, in a case of switching an avatar of the same user, it is sufficient for the control system 20 to switch the image of the avatar to be synthesized with the image of the actual user. The user has been described as an example, the same applies to the provider.

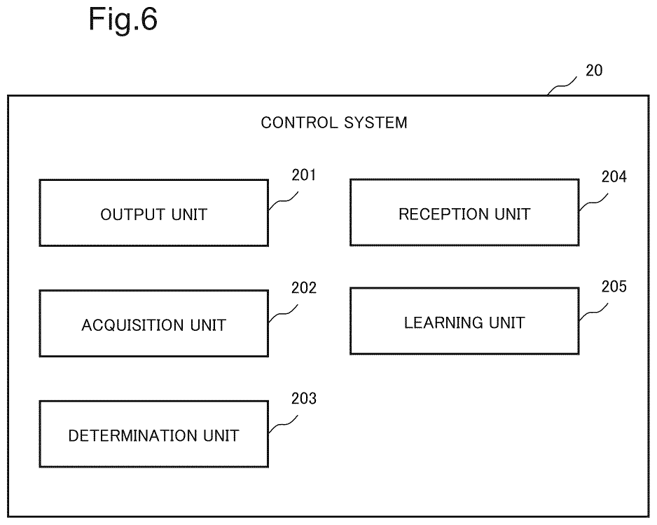

FIG. 6 is a second block diagram illustrating a configuration example of the control system 20 according to the present disclosure.

The control system 20 includes an output unit 201, an acquisition unit 202, a determination unit 203, a reception unit 204, and a learning unit 205.

The output unit 201 may have the function of the output unit 101 illustrated in FIG. 1 as a basic function. The acquisition unit 202 may have the function of the acquisition unit 102 illustrated in FIG. 1 as a basic function. The determination unit 203 may have the function of the determination unit 103 illustrated in FIG. 1 as a basic function.

Here, the avatar of the user and the avatar of the provider may be determined both at a service use start time and during the use of the service.

### <Service Use Start Time>

First, the acquisition unit 202 acquires an action history of the user. The action history of the user here may be an action history at the time of service use in the past. The action history of the user at the time of service use in the past may include voice information of the user in a conversation with the provider, information regarding an image actually viewed by the user in a virtual reality space, and biometric information of the user. The action history of the user at the service use start time may include, for example, information indicating a past purchase history and a purchase tendency. The purchase history may include, for example, information regarding a product purchased by the user and information regarding a purchase frequency, a purchase amount, a purchase date and time, or the like. The acquisition unit 202 may acquire attribute information indicating an attribute of the user, without limiting to the action history of the user. The attribute of the user is an age, a gender, an occupation, an address, or the like of the user and is not particularly limited. The acquisition unit 202 may acquire a use history of the service of the user in the past. For example, the use history of the service may include, for example, information such as a past avatar, the number of times of use, a use frequency, or provider identification information for identifying a provider who has provided the service to the user in the past, and the use history of the service is not particularly limited.

Here, various types of information of the user such as the action history or the attribute information of the user may be stored as a user database in association with user identification information for identifying the user in advance. Then, for example, when receiving the user identification information, the acquisition unit 202 acquires various types of information of the user associated with the user identification information, from the user database.

The acquisition unit 202 acquires the action history of the provider at the time of service provision in the past. The action history of the provider may include voice information of the provider, biometric information of the provider, and image information of the provider. The acquisition unit 202 may acquire attribute information indicating an attribute of the provider and a provision history of the provider, without limiting to the action history of the provider. The attribute information is an age, a gender, a work experience, or the like of the provider and is not particularly limited. The provision history may include, for example, the past avatar, information such as the user identification information for identifying the user to whom the service has been provided in the past, and the provision history of the service is not particularly limited. The provision history may be also referred to as a work history, for example.

Here, various types of information of the provider such as the action history or the attribute information of the provider may be stored as a provider database in association with the provider identification information for identifying the provider in advance. Then, for example, when receiving the provider identification information, the acquisition unit 202 acquires various types of information of the provider associated with the provider identification information, from the provider database.

<Determination about at Least One of Avatar and Action of Provider at the Time of Service Start>

The determination unit 203 determines the avatar of the provider and the action of the avatar of the provider at the time of service start, based on the action history of the user. A method for determining the avatar of the provider may be similar to, for example, the method for determining the avatar of the provider who is providing the service, described in the first example embodiment. For example, the determination unit 203 may determine the avatar of the provider and the action of the avatar of the provider, using a table or a model. For example, in a case where the model is used, the learning unit 205 generates the model in advance, as preparation in advance. The learning unit 205 generates a model that has learned a relationship between the action history of the user and the avatar of the provider and the action of the avatar, based on past action histories of a plurality of users and an avatar of the provider and an action of the avatar at the time when each of the plurality of users uses the service. Then, the determination unit 203 may input the action history of the user into the learned model and acquire the avatar of the provider and the action of the avatar from the model.

The determination unit 203 may determine at least one of the avatar of the provider and the action of the avatar of the provider at the time of service start, based on the action history of the user and the attribute information of the user. More specifically, for example, the determination unit 203 may determine at least one of an avatar close to the age of the user and an action of the avatar close to the age of the user. More specifically, for example, the determination unit 203 may determine at least one of an avatar of the same gender as the user and an action of the avatar of the same gender as the user. More specifically, for example, the determination unit 203 may determine the action of the avatar estimated from the occupation of the user. For example, the determination unit 203 may determine a speaking way of the avatar of the provider according to a personality estimated from the occupation of the user. It is sufficient to use a table or a model for the method for determining the avatar of the provider and the action of the avatar, based on the action history of the user and the attribute information of the user. It is sufficient to generate the model by the learning unit 205 in advance.

Here, in a case where there is a plurality of users, the determination unit 203 determines at least one of the avatar of the provider and the action of the avatar visible to each of the plurality of users, based on the action history of the user, for each of the plurality of users. Taking users A and B as an example, the determination unit 203 determines at least one of an avatar of a provider visible to the user A and an action of the avatar, based on an action history of the user A. Then, the determination unit 203 determines at least one of an avatar of a provider visible to the user B and an action of the avatar, based on an action history of the user B. The avatar of the provider visible to the user A and the action of the avatar and the avatar of the provider visible to the user B and the action of the avatar may be the same or different.

For example, the determination unit 203 may determine the action of each user in such a way that an ability of the user A and an ability of the user B are balanced.

Then, the output unit 201 outputs the avatar of the provider who provides the service and the action of the avatar, to the display device 21 of the user of the service in a VR space.

An example has been described in which the determination unit 203 determines at least one of the avatar and the action of the provider using the past action history. However, for example, the output unit 201 may output a predetermined avatar and an action of the avatar determined in advance. For example, in a case where it is not possible to obtain the past action history or the like, the output unit 201 may output the predetermined avatar and the action of the avatar determined in advance to the display device 21 of the user of the service.

<Determination about at Least One of Avatar and Action of User at the Time of Service Start>

The determination unit 203 may determine the avatar of the user and the action of the avatar of the user to be displayed on the display device 21 of the provider, based on the action history of the user. For example, the determination unit 203 may determine at least one of the avatar of the user and the action of the avatar according to the action history of the user. For example, the avatar of the user according to the action history of the user may be, for example, an avatar of a user indicating the personality of the user estimated from the action history of the user. The action of the avatar of the user according to the action history of the user may be, for example, an action of the avatar of the user indicating the personality of the user estimated from the action history of the user. As a result, the provider can grasp the personality of the user at a glance.

For example, the determination unit 203 may determine the avatar of the user and the action of the avatar of the user to be displayed on the display device 21 of the provider, based on the action history of the user and the attribute information of the user. For example, the avatar of the user according to the attribute information of the user may be, for example, an avatar of the user indicating the attribute of the user. For example, the determination unit 203 may determine the avatar of the user close to the age of the user.

The determination unit 203 may determine the avatar of the user to be displayed on the display device 21 of the provider, based on the use history of the service of the user in the past. For example, the determination unit 203 may display an avatar same as an avatar of the user displayed in the past, on the display device 21 of the provider. This can cause the provider to easily confirm the user.

Then, the output unit 201 outputs the avatar of the provider who provides the service and the action of the avatar, to the display device 21 of the provider of the service in the VR space.

An example has been described in which the determination unit 203 determines at least one of the avatar and the action of the provider using the past action history. However, for example, the output unit 201 may output a predetermined avatar and an action of the avatar determined in advance. For example, in a case where it is not possible to obtain the past action history or the like, the output unit 201 may output the predetermined avatar and the action of the avatar determined in advance to the display device 21 of the user of the service.

<Processing Example at Service use Start Time in a Case where there is Plurality of Users>

Here, in a case where there is the plurality of users, the determination unit 203 determines at least one of an avatar and an action visible to each of the plurality of users, based on an action history of each of the plurality of users.

Taking the users A and B as examples, in a case where the users A and B have interactions with each other, the determination unit 203 determines at least one of an avatar of the user B visible to the user A in the VR space and an action of the avatar, based on an action history of the user A. For example, the determination unit 203 determines at least one of the avatar of the user B and the action of the avatar according to a personality and a state of the user A. Then, the determination unit 203 determines at least one of an avatar of the user A visible to the user B in the VR space and an action of the avatar, based on an action history of the user B. For example, the determination unit 203 determines at least one of the avatar of the user A and the action of the avatar according to a personality and a state of the user B. As a result, it is possible to facilitate the interaction, such that the users A and B can easily talk to each other.

Then, the output unit 201 outputs at least one of an avatar of another user and an action that have been determined, to the display device 21 of the user.

### <During use of Service>

Next, an example will be described in which at least one of the avatar of the provider and the action of the avatar is determined during use of the service. Regarding content described in the first example embodiment, detailed description is omitted.

Next, as described in the first example embodiment, the acquisition unit 202 acquires the action history of the user who is using the service. The action history of the user may include the voice information of the user, the biometric information of the user, image information of the user, or the like.

The acquisition unit 202 acquires the action history of the provider who is providing the service. The action history of the provider of the service may include the voice information of the provider, the biometric information of the provider, and the image information of the provider. The action history of the provider who is providing the service is acquired via a device such as a wearable device attached to an actual provider or a device such as an imaging device that can image the provider or a sound collection device that can collect sound such as voice. For example, the biometric information can be acquired via the wearable device, the imaging device, or the like. The voice information can be acquired via the sound collection device or the like. In a case where the display device is a Head Mounted Display (HMD), the action history may be acquired via the HMD worn by the provider. For example, if the display device is the HMD, the acquisition unit 102 can acquire line-of-sight information of the provider or the like, as the action history.

Then, as described in the first example embodiment, for example, the determination unit 203 determines at least one of the avatar of the provider of the service and the action of the avatar in the VR space, based on the action history of the user who is using the service. As described in the first example embodiment, the provider of the service for which the determination unit 203 determines the avatar or the action may be a provider different from the provider who is providing the service to the user or may be the provider who is providing the service to the user. The method for determining at least one of the avatar of the provider of the service and the action of the avatar by the determination unit 203 is as described in the first example embodiment. For example, as described in the first example embodiment, in a case where the determination unit 203 determines the avatar of the provider, a table or a model may be used.

For example, in a case where the model is used, the learning unit 205 generates the model in advance, as preparation in advance.

Specifically, for example, the learning unit 205 generates a model that has learned a relationship between the action history of the user and the avatar of the provider and the action of the avatar, based on the past action histories of the plurality of users and the avatar of the provider and the action of the avatar at the time when each of the plurality of users uses the service. For example, the learning unit 205 may generate a model that has learned a relationship between the action history of the user and the changes in the avatar and the action of the avatar, based on past action histories of a plurality of customers and changes in an avatar of a clerk and an action of the avatar while the service is provided to the user.

Then, for example, the determination unit 203 may input an action history of a current customer and an avatar of a current clerk and an action of the avatar into the model learned by the learning unit 205 and determine a new avatar and an action of the avatar.

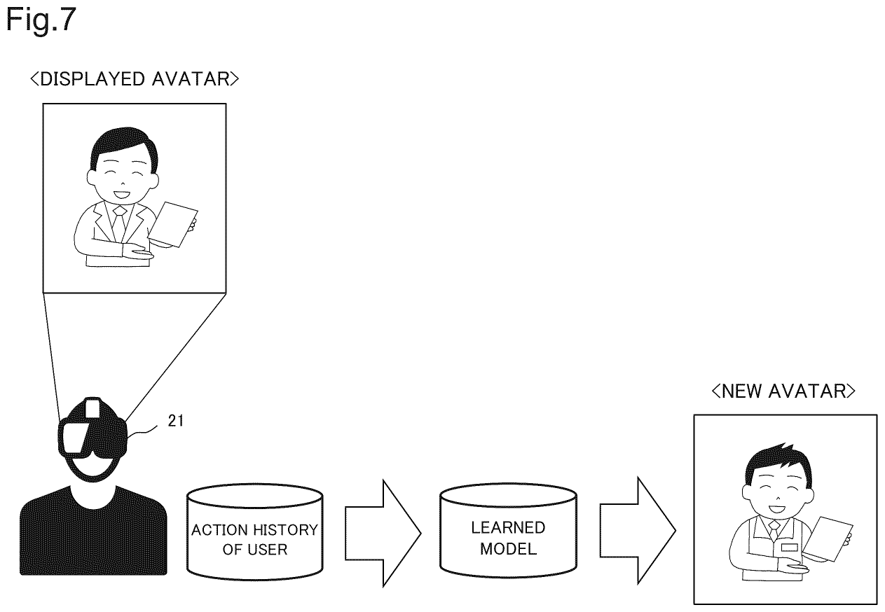

FIG. 7 is an explanatory diagram illustrating an example of determining a new avatar by a learning model. In FIG. 7, a case has been described as an example, in which the service is a customer service, the user is a customer, and the provider is a clerk. For example, the output unit 201 displays the avatar of the clerk in the VR space, on a display device 21 of the customer.

For example, the acquisition unit 202 acquires the action history of the customer during service provision. Then, for example, the determination unit 203 determines at least one of the avatar of the clerk and the action of the avatar, by inputting the action history of the customer into the learned model. In FIG. 7, the determination unit 203 determines an avatar that is a clerk same as the clerk currently displayed and has clothes and hairstyle different from those of the avatar of the clerk currently displayed. For example, the output unit 201 switches at least one of the avatar and the action of the clerk of the service to at least one of the determined avatar and action of the clerk and outputs it.

Here, a timing when the output unit 201 performs switching is not particularly limited. For example, the output unit 201 may perform switching at a timing of a new conversation or may perform switching in stages. For example, the output unit 201 may perform switching in response to an instruction of the provider of the service or may perform switching in response to an instruction of the user of the service.

First, an example will be described in which switching is performed in response to the instruction of the provider of the service.

For example, the reception unit 204 receives an avatar switching instruction from the provider. The reception unit 204 receives the switching instruction by an operation of the provider via an input device. A type of the input device is a controller, a pen tablet, or the like and is not particularly limited. For example, upon receiving the switching instruction, the output unit 201 switches at least one of the avatar and the action of the provider to at least one of the determined avatar and action of the provider and outputs at least one of the determined avatar and action.

Next, an example will be described in which switching is performed in response to the instruction of the user of the service. For example, the reception unit 204 receives an avatar switching instruction from the user. The reception unit 204 receives the switching instruction by an operation of the provider via an input device. For example, upon receiving the switching instruction from the user, the output unit 201 switches at least one of the avatar and the action of the provider to at least one of the determined avatar and action of the provider and outputs at least one of the determined avatar and action of the provider.

In order to receive the instruction, the output unit 201 may output the avatar of the provider and the action of the avatar that are currently displayed and the determined avatar and action of the avatar to a device of an instructor who issues a switching instruction. The instructor may be the provider or the user, as described above. The device of the instructor may be, for example, a display device 21 of the instructor or another terminal device, and is not particularly limited.

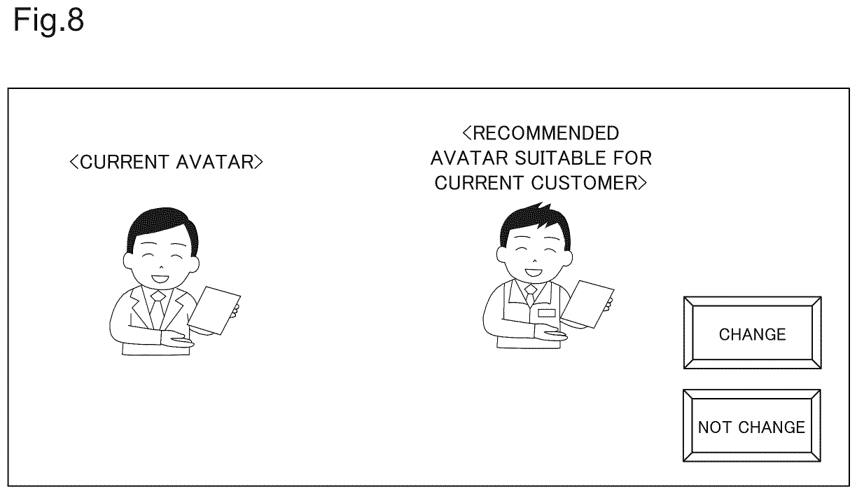

FIG. 8 is an explanatory diagram (part 1) illustrating an example of a screen for receiving an instruction. In FIG. 8, the output unit 201 displays an avatar of a provider currently displayed and an avatar whose clothes have been changed from the avatar of the provider, side by side on the screen. In FIG. 8, for example, the screen further includes a change button. When the change button is pressed by an operation of the instructor, the reception unit 204 receives the switching instruction. Then, when the reception unit 204 receives the switching instruction, the output unit 201 switches at least one of the avatar and the action of the provider to at least one of the determined avatar and action of the provider and outputs at least one of the determined avatar and action of the provider.

In FIG. 8, for example, the screen may include a non-change button. When the non-change button is pressed by the operation of the instructor, the reception unit 204 receives an instruction not to perform switching. Then, the output unit 201 outputs the current avatar and the current action of the provider.

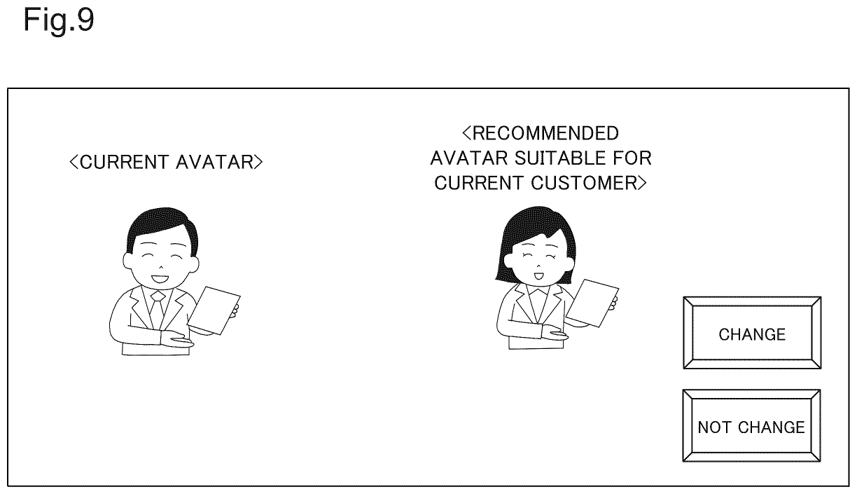

FIG. 9 is an explanatory diagram (part 2) illustrating an example of receiving an instruction. In FIG. 9, the output unit 201 displays the avatar of the provider currently displayed and an avatar of the different gender from the avatar of the provider, side by side on the screen. In FIG. 9, for example, the screen further includes a change button. When the change button is pressed by the operation of the instructor, the reception unit 204 receives the switching instruction. Then, when the reception unit 204 receives the switching instruction, the output unit 201 outputs at least one of the avatar and the action of the provider by switching at least one of the avatar and the action of the provider to at least one of the determined avatar and action of the provider.

In FIG. 9, for example, the screen may include a non-change button. When the non-change button is pressed by the operation of the instructor, the reception unit 204 receives an instruction not to perform switching. Then, the output unit 201 outputs the current avatar and the current action of the provider.

In a case of receiving the instruction not to perform switching, the determination unit 203 may newly determine at least one of another avatar and an action of the avatar.

For example, in a case where the provider of the service for which at least one of the avatar and the action is determined by the determination unit 203 is a provider different from the provider who is currently providing the service to the user, the output unit 201 may output the additionally determined avatar of the provider, while outputting the avatar of the provider who is currently providing the service or may output a newly determined avatar of the provider, without outputting the avatar of the provider who is currently providing the service. That is, the output unit 201 may output at least one of the newly determined avatar and action to add the provider or may output at least one of the newly determined avatar and action to change the provider. Such output switching may be performed in response to the instruction of the operator.

For example, the determination unit 203 may determine at least one of the avatar and the action of the provider, based on the action history of the provider and the action history of the user. Specifically, for example, the determination unit 203 may determine at least one of the avatar and the action of the provider, in such a way that a state of the provider and a state of the user match. For example, in a case where the user is nervous although the provider is not nervous, it is assumed that the provider can easily talk but it be difficult for the user to talk.

Therefore, the determination unit 203 may determine at least one of the avatar and the action of the provider that lowers a tension degree of the user. As an example of changing the avatar for lowering the tension degree, the determination unit 203 may determine to change the age and gender of the avatar of the provider, from an age and a gender of the avatar of the provider that is currently displayed on the display device 21 of the user. As an example of changing the action of the avatar for lowering the tension degree, the determination unit 203 may determine a voice quality of the avatar of the provider in such a way as to change a voice quality of the avatar of the provider currently displayed on the display device 21 of the user to a gentle voice quality or a mild voice quality. This can facilitate the conversation between the user and the provider.

The output unit 201 switches at least one of the avatar and the action of the provider to at least one of the determined avatar and action of the provider and outputs at least one of the determined avatar and action of the provider.

### <Change at Least One of Avatar and Action of User>

For example, the determination unit 203 may determine at least one of the avatar of the user and the action of the avatar of the user to be displayed on the display device 21 of the provider, based on the action history of the user. As in the example at the time of use start, for example, the determination unit 203 may determine at least one of the avatar of the user and the action of the avatar according to the action history of the current user. For example, the avatar of the user according to the action history of the user may be, for example, an avatar of a user indicating the personality of the user estimated from the action history of the user. The action of the avatar of the user according to the action history of the user may be, for example, an action of the avatar of the user indicating the personality or the state of the user estimated from the action history of the user. As a result, the provider can grasp the personality or the state of the user at a glance. For example, in a case where it is estimated that the user is currently nervous from a pulse included in the biometric information, the determination unit 203 determines an avatar from which it can be found that the user is nervous.

The output unit 201 switches at least one of the avatar and the action of the user that are currently displayed to at least one of the determined avatar and action of the user and outputs at least one of the determined avatar and action to the display device 21 of the provider. Here, the timing when the output unit 201 performs switching is not particularly limited. For example, the output unit 201 may perform switching at a timing of a new conversation or may perform switching in stages. For example, the output unit 201 may perform switching in response to an instruction of the provider of the service or may perform switching in response to an instruction of the user of the service. Since an example in which the reception unit 204 receives the switching instruction may be similar to the example in which the avatar and the action of the provider are switched, detailed description is omitted.

The output unit 201 may output the state of the user, together with the avatar. For example, in a case where the state of the user is the tension degree, the output unit 201 may output the tension degree, together with the avatar.

### <Determine at Least One of Avatar and Action of User>

For example, since the provider becomes nervous during the conversation with the user, the avatar of the provider may be changed in such a way that the provider can easily talk. Therefore, for example, the determination unit 203 determines at least one of the avatar and the action of the user to be displayed on the display device 21 of the provider, based on the action history of the provider. For example, the determination unit 203 may determine at least one of the avatar and the action of the user according to the state of the provider estimated from the action history of the provider. For example, it is sufficient to use a table or a model for the determination method for determining the avatar and the action of the user by the determination unit 203, similarly to the determination method for determining the avatar and the action of the provider by the determination unit 203.

The output unit 201 switches at least one of the avatar and the action of the user that are currently displayed on the display device 21 of the provider, to at least one of the determined avatar and action of the user and outputs at least one of the determined avatar and action. Here, the timing when the output unit 201 performs switching is not particularly limited. For example, the output unit 201 may perform switching at a timing of a new conversation or may perform switching in stages. For example, the output unit 201 may perform switching in response to an instruction of the provider of the service or may perform switching in response to an instruction of the user of the service. Since an example in which the reception unit 204 receives the switching instruction may be similar to the example in which the avatar and the action of the provider are switched, detailed description is omitted.

In the example described above, the action of the avatar of the provider in the VR space may be that of a bot.

For example, the output unit 201 may output a plurality of actions of the avatar of the provider who is the bot in the VR space. Then, for example, the reception unit 204 may receive selection of the action by an operation of an actual instructor, from among the plurality of actions of the avatar of the provider who is the bot.

### <Determine Sound Effect>

The determination unit 203 may further determine a sound effect.

Specifically, the determination unit 203 may determine the sound effect, based on the action history of the user. For example, the determination unit 203 may determine a sound effect according to the state of the user estimated from the biometric information of the user. For example, the determination unit 203 may determine a sound effect according to the personality of the user estimated from the action history of the user. The sound effect may be music or the like. Alternatively, in a case where the service is a customer service, the sound effect may be, for example, voice of another customer or the like.

Then, the output unit 201 outputs the determined sound effect with the voice output device included in the display device 21.

<Example of Case where Service is Customer Service>

In a case where the service is a customer service, the user is a customer, and the provider is a clerk. In a case where the service is the customer service, an avatar and an action of a clerk that improve customer's willingness to purchase are desirable.

For example, the past action history of the user further includes the purchase history of the user, and the model may be, for example, a model that has learned a relationship between the action history of the user and the avatar of the provider and the action of the avatar, based on the past action histories of the plurality of users and the avatar of the provider and the action of the avatar at the time when each of the plurality of users uses the service. The model may be a model that has learned a relationship between the action history of the user and the changes in the avatar of the provider and the action of the avatar. For example, it is sufficient to generate a model that can obtain the avatar of the provider and the action of the avatar that increase the willingness to purchase.

For example, as an example of changing the avatar of the clerk, a hairstyle of the clerk, clothes of the clerk, an atmosphere of the clerk may be changed. For example, in a case where the customer prefers a luxurious atmosphere, the determination unit 203 determines a hairstyle, clothes, and an atmosphere of the avatar of the clerk according to the preference. The preference of the customer or the like may be estimated from an utterance of the customer or a state of the customer.

For example, depending on the customer, there is a case where the willingness to purchase is improved by seeing a scene where another customer is shopping. For example, the past action history of the customer may include a past purchase history. The past action history of the customer may include information indicating a purchasing scene of the customer before and after a time when a product has been purchased in the past purchase history. The information indicating the purchasing scene may be an analysis result of a video or information regarding a memo input by the clerk. The acquisition unit 202 may acquire the past action history of the user. Therefore, the determination unit 203 may determine a purchasing scene by another user, based on the purchasing scene at the time when the product has been purchased in the past in the purchase history included in the action history. Then, for example, in a case where the user has purchased, in the past purchase, the same product after seeing another user purchasing the product, the determination unit 203 may determine a purchasing scene in which another user purchases a product that the clerk currently recommends to the customer. The another user here may be another customer having a close attribute to the customer. Then, the output unit 201 outputs the determined purchasing scene to the display device 21 of the customer. For example, the output unit 201 may display the determined scene as a background.

Here, although an example in which a scene is displayed has been described by taking the customer service as an example, the present invention may be applied to an example of other services.

For example, in a case of a customer service work, the clerk may perform an accounting work such as a cash register. In such a case, in a case where there are many other users, it is desirable to shorten a customer service time for one user. Therefore, the determination unit 203 may determine the action of the provider of the service, based on the number of users of the service. For example, in a case where the number of users of the service is large, the determination unit 203 may determine the action of the provider in such a way that an utterance of explanation of the service or the like is shortened. That is, in a case where the number of users of the service is large, the determination unit 203 may determine the action of the provider in such a way that the customer service time is shortened. The number of users may be determined based on a threshold or the like and the number of clerks. The action of the provider may be determined based on an environment in which the service is currently provided, in addition to the number of users of the service.

Example of Case where Service is Medical Counseling

In a case where the service is medical counseling, the user is a patient, and the provider is a doctor. In such a case, an avatar and an action of the doctor that make it easier for the patient to talk to the doctor are desired.

In a case of the medical counseling, even if the number of actual patients is one, the VR space may be set to an environment in which group counseling is received. Alternatively, an avatar of an actual patient and an avatar of a bot patient may be mixed. In addition, an avatar of an actual doctor and an avatar of a bot doctor may be mixed.

Therefore, the determination unit 203 may determine the number of other patients visible to the patient, based on an action history of the patient who is using the service. For example, the determination unit 203 may determine the number of other patients visible to the patient, based on a personality or a state of the patient estimated from the action history of the patient. It is sufficient to use a table or a model for a determination method for determining the number of other patients by the determination unit 203. For example, the model is learned by the learning unit 205 in advance. For example, in a case of a patient who can easily talk by listening to content spoken by other patients, the patient can more easily talk by increasing the number of patients. Then, the output unit 201 outputs avatars and actions of the determined number of other patients. Here, the output unit 201 outputs the avatars and the actions of the determined number of other patients to the display device 21 of the user. Moreover, the output unit 201 outputs the avatars and the actions of the determined number of other patients to the display device 21 of the provider.

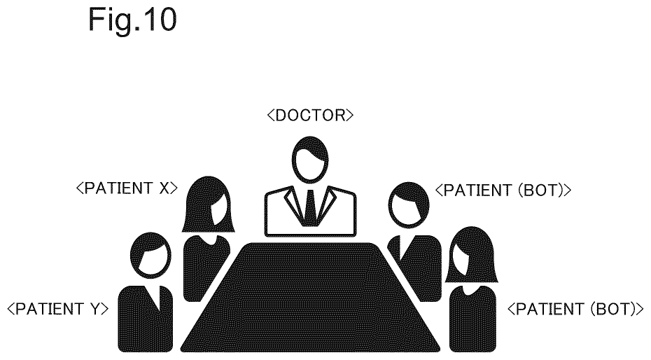

FIG. 10 is an explanatory diagram illustrating an output example of the determined number of patients. For example, in actuality, there are a patient X, a patient Y, and a doctor. In the VR space, an avatar of the patient X, an avatar of the patient Y, and an avatar of the doctor are displayed. Then, in a case where the determination unit 203 determines that there are four patients, since the number of actual patients is two, the output unit 201 outputs avatars of other two patients to the display device 21 of each patient. Then, it is sufficient for the output unit 201 to output actions of the avatars of the two patients who do not actually exist as bots.

Although an example in which the service is being used has been taken as an example, the determination unit 203 may determine the number of other patients visible to the patient, based on a past action history of the patient, before the start of the service use. Then, the output unit 201 may output the avatars and the actions of the determined number of other patients.

Here, although an example has been described in which another virtual user is displayed, taking the medical counseling as an example, the present invention may be applied to an example of other services.

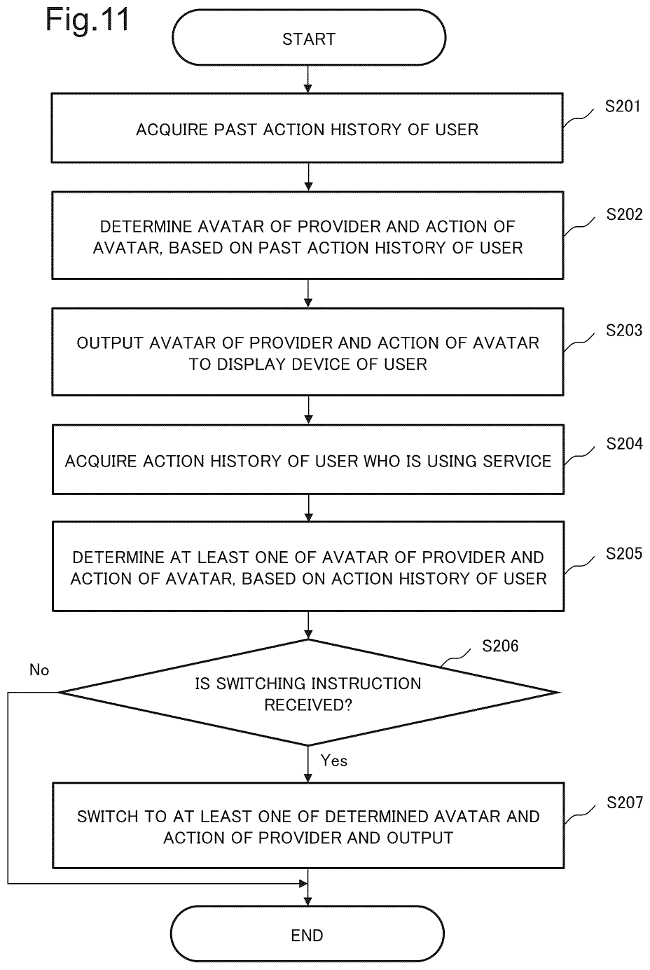

FIG. 11 is a flowchart illustrating an operation example of the control system 20 that switches at least one of the avatar and the action of the user. The acquisition unit 202 acquires the past action history of the user (step S201). The determination unit 203 determines the avatar of the provider and the action of the avatar, based on the past action history of the user (step S202). The output unit 201 outputs the avatar of the provider and the action of the avatar to the display device 21 of the user (step S203).

When the use of the service starts, the acquisition unit 202 acquires the action history of the user who is using the service (step S204). For example, step S204 may be performed after a predetermined time has elapsed from the service start or may be performed at a timing based on content of the conversation.

The determination unit 203 determines at least one of the avatar of the provider and the action of the avatar, based on the action history of the user (step S205). The reception unit 204 determines whether the switching instruction is received (step S206). The instructor of the switching instruction may be the provider or the user. In a case where the switching instruction is received (step S206: Yes), the output unit 201 performs switching to and outputs at least one of the determined avatar and action of the provider (step S207), and the control system 20 ends the processing. In a case where the switching instruction is not received (step S206: No), the control system 20 ends the processing. The control system 20 may return to step S204 after step S207 or after a case of No in step S206 and repeatedly perform the processing while using the service.

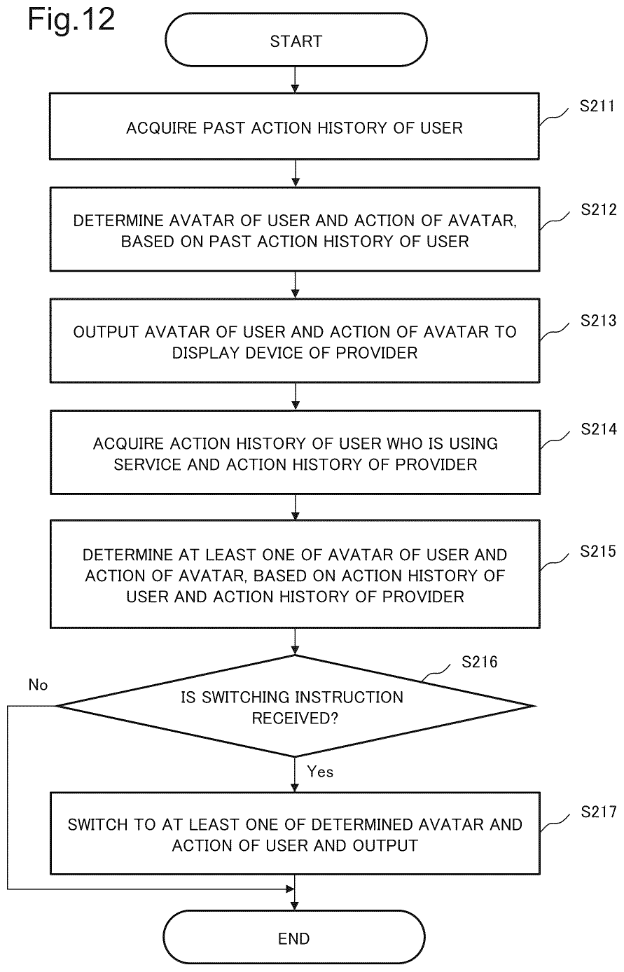

FIG. 12 is a flowchart illustrating an operation example of the control system 20 that switches at least one of the avatar and the action of the provider. In FIG. 12, an example is described in which the determination unit 203 determines at least one of the avatar of the user and the action of the avatar, based on the action history of the user.

The acquisition unit 202 acquires the past action history of the user (step S211). The determination unit 203 determines the avatar of the user and the action of the avatar, based on the past action history of the user (step S212). The output unit 201 outputs the avatar of the provider and the action of the avatar to the display device 21 of the provider (step S213).

When the use of the service starts, the acquisition unit 202 acquires the action history of the user who is using the service (step S214). For example, step S214 may be performed after a predetermined time has elapsed from the service start or may be performed at a timing based on content of the conversation.

The determination unit 203 determines at least one of the avatar of the user and the action of the avatar, based on the action history of the user (step S215). The reception unit 204 determines whether the switching instruction is received (step S216). In a case where the switching instruction is received (step S216: Yes), the output unit 201 performs switching to and outputs at least one of the determined avatar and action of the provider (step S217), and the control system 20 ends the processing. In a case where the switching instruction is not received (step S216: No), the control system 20 ends the processing. The control system 20 may return to step S214 after step S217 or after a case of No in step S216 and repeatedly perform the processing while using the service.

The operation example illustrated in FIG. 11 and the operation example illustrated in FIG. 12 may be performed in one flow.

In the second example embodiment above, in a case where there is the plurality of users, the control system 20 determines at least one of the avatar and the action visible to each of the plurality of users, based on the action history of each of the plurality of users while using the service and outputs at least one of the avatar and the action of the user determined for each of the plurality of users. As a result, the avatars that can be seen by the users from each other can be avatars suitable for the state of the user who is using the service. For example, the user can easily have a conversation, or the tension degree can be lowered. Therefore, it is possible to facilitate use of the service by the user of the service.

In a case where there is the plurality of users, the control system 20 determines at least one of the avatar of the provider of the service and the action of the avatar visible to each of the plurality of users, based on the action history of each of the plurality of users, and performs switching to and outputs at least one of the determined avatar and action of the provider for each of the plurality of users. As a result, even in a case where there is the plurality of users, at least one of the avatar and the action of the provider is output for each user in the VR space. Therefore, even in a case where the plurality of users uses the service, it is possible to facilitate the use of the service by each user.

The control system 20 determines the avatar of the provider of the service, based on the past action history of the user, before the start of the service and outputs the determined avatar of the provider. As a result, the avatar of the provider according to the past action history of the user is displayed on the display device 21 of the user before the start of the service. Therefore, it is possible to facilitate use of the service by the user of the service.

The control system 20 outputs the avatar and the action of the user to the display device 21 of the provider. Then, the control system 20 determines at least one of the avatar and the action of the user, based on the action history of the user and switches at least one of the avatar and the action of the user to at least one of the determined avatar and action of the user and outputs it. As a result, during the service provision, at least one of the avatar and the action of the user suitable for the action history of the user is displayed on the display device 21 of the provider. Therefore, the provider can easily provide the service.

The control system 20 outputs the avatar and the action of the user in the VR space to the display device 21 of the provider. The control system 20 determines at least one of the avatar and the action of the user, based on the action history of the provider who is providing the service. Then, the control system 20 switches at least one of the avatar and the action of the user to at least one of the determined avatar and action of the user and outputs at least one of the determined avatar and action to the display device 21 of the provider. As a result, during the service provision, at least one of the avatar and the action of the user suitable for the action history of the provider is displayed on the display device 21 of the provider. Therefore, the provider can easily provide the service.

The control system 20 determines the avatar and the action of the provider, based on the action history of the provider who is providing the service and the action history of the user and switches at least one of the avatar and the action of the provider to at least one of the determined avatar and action of the provider and outputs at least one of the determined avatar and action. As a result, during the service provision, at least one of the avatar and the action of the provider according to the action history of the provider and the action history of the user is displayed on the display device 21 of the user. Therefore, the provider can easily provide the service.

As the method for determining the avatar and the action of the provider, the control system 20 may determine at least one of any one avatar and any one action, from the plurality of avatars and the plurality of actions determined in advance. The control system 20 may input the acquired action history of the user into the learned model and determine at least one of the avatar and the action of the provider of the service. In a case where the learning model is used, the control system 20 generates a model that has learned a relationship between the action history of the user and the avatar of the provider and the action of the avatar, based on the past action histories of the plurality of users and the avatar of the provider and the action of the avatar at the time when each of the plurality of users uses the service.

The control system 20 determines at least one of the avatar of the provider different from the provider who is providing the service to the user and the action of the avatar. As a result, during the service provision, it is possible to newly assign another provider who allows the user to easily use the service to the user. For example, the control system 20 determines at least one of the avatar of the provider who is providing the service to the user and the action of the avatar. This makes it possible to facilitate the use of the service by the user of the service, without changing the provider who is providing the service to the user.

The control system 20 may perform various types of switching in response to the instruction of the provider. Alternatively, the control system 20 may perform various types of switching in response to the instruction of the user. In this way, by performing switching at a desired timing by the provider or the user, it is possible to reduce discomfort at the time of switching.

The control system 20 may further determine the sound effect and output the determined sound effect. This makes it possible to provide a more realistic service.

The user may be the customer, and the provider may be the clerk. For example, there is a customer whose willingness to purchase is increased by viewing a purchasing scene of another customer. Therefore, for example, the control system 20 may determine the purchasing scene by another user, based on the purchasing scene at the time when a product is purchased in the past in the purchase history and output the determined purchasing scene. This makes it possible to improve the willingness to purchase of the user.

The user is the patient, and the provider is the doctor. The control system 20 determines the number of other patients visible to the user, based on the action history and outputs the avatars of the determined number of other patients. For example, in a case of a patient who can easily talk by listening to content spoken by other patients, the patient can more easily talk by increasing the number of patients. In a case of a patient who feels difficult to talk if the number of other patients is large, the determined number of patients may be zero. In this way, it is possible to provide the service on the VR space that can further facilitate the conversation by the user.

The description of each example embodiment is ended. The example embodiments may be combined. In the example embodiments, the control systems 10 and 20 may have a configuration including each functional unit and a part of information.

The description of the application example ends. The example embodiments are not limited to the examples described above, and various modifications can be made. The configurations of the control systems 10 and 20 in the example embodiments are not particularly limited. For example, functional units of the control systems 10 and 20 may be achieved by a single device such as a control device. Alternatively, for example, each functional unit of the control systems 10 and 20 in the example embodiments may be achieved by a different device for each DataBase (DB). For example, each functional unit of the control system 20 may include a plurality of servers and be achieved as the control system 20. For example, the control system 20 may be achieved by a database server including each DB and a server including each functional unit. In the example embodiment, each piece of information may include a part of the above-described information. Each piece of information may include information other than the above-described information.

The processing for generating the information or the like to be displayed on the display device 21 may be performed by the output units 101 and 201. This processing may be performed by the display device 21. That is, the display device 21 generates information on the screen displayed on the display device 21 based on data received from the control systems 10 and 20 and displays the screen.

### (Hardware Configuration Example of Computer)

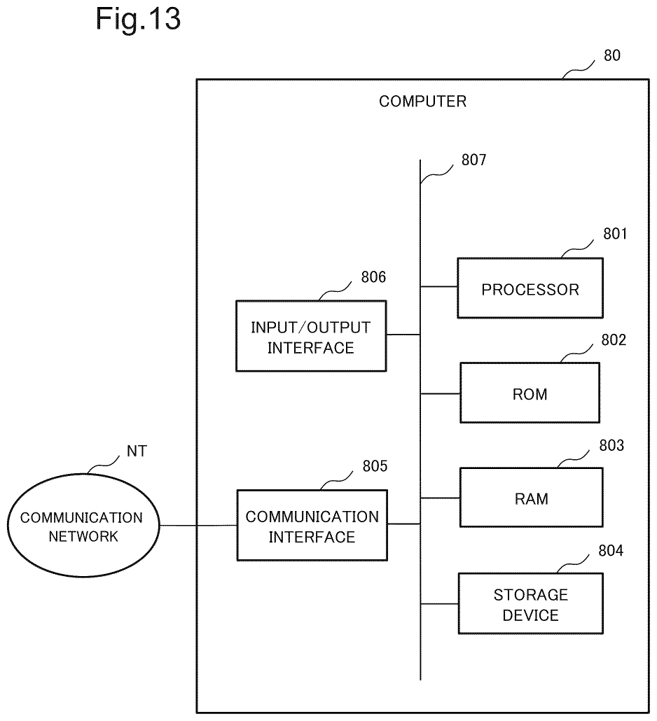

Next, a hardware configuration example in a case where each device in the control systems 10 and 20, the display device 21, or the like described in each example embodiment is achieved by a computer will be described. FIG. 13 is an explanatory diagram illustrating a hardware configuration example of a computer. For example, some or all of the devices can be achieved by using any combination of a computer 80 and a program as illustrated in FIG. 13.

The computer 80 includes, for example, a processor 801, a Read Only Memory (ROM) 802, a Random Access Memory (RAM) 803, and a storage device 804. The computer 80 includes a communication interface 805 and an input/output interface 806. The components are connected via a bus 807, for example. The number of each component is not particularly limited, and the number of each component is one or more.

The processor 801 controls the entire computer 80. As the processor 801, for example, a Central Processing Unit (CPU), a Digital Signal Processor (DSP), a Graphics Processing Unit (GPU), a Physics Processing Unit (PPU), a Tensor Processing Unit (TPU), a quantum processor, a combination thereof, or the like can be used, and is not particularly limited.

The computer 80 includes the ROM 802, the RAM 803, the storage device 804, and the like. Examples of the storage device 804 include a semiconductor memory such as a flash memory, a Hard Disk Drive (HDD), a Solid State Drive (SSD), and the like. For example, the storage device 804 stores an Operating System (OS) program, an application program, a program according to the example embodiments, and the like. Alternatively, the ROM 802 stores an application program, a program according to the example embodiment, and the like. Then, the RAM 803 is used as a work area of the processor 801.

The processor 801 loads the program stored in the storage device 804, the ROM 802, or the like. Then, the processor 801 executes each processing coded in the program. The processor 801 may download various programs via a communication network NT. The processor 801 functions as part or all of the computer 80. The processor 801 may execute processes or instructions in the flowchart illustrated based on the program.

The communication interface 805 is connected to the communication network NT such as a LAN or a Wide Area Network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. Then, the communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a voice output device that outputs a voice. Examples of the input/output device include a touch panel display. The input device, the output device, the input/output device, and the like may be built in the computer 80 or may be externally attached.

The hardware configuration of the computer 80 is an example.

The computer 80 may have some components illustrated in FIG. 13. The computer 80 may have components other than those illustrated in FIG. 13. For example, the computer 80 may include a drive device or the like.

The processor 801 may read a program or data stored in a recording medium attached to the drive device or the like into the RAM 803.

Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). A type of the sensor is not particularly limited. The computer 80 may include an imaging device capable of capturing images and videos.

The description of the hardware configuration of each device is ended. There are various modifications in a method of achieving each device. For example, each device may be achieved by any combination of a computer and a program different for each component. A plurality of components included in each device may be achieved by any combination of one computer and a program.

A part or all of each component of each device may be achieved by an application specific circuit. A part or all of each component of each device may be achieved by a general-purpose circuit such as a Field Programmable Gate Array (FPGA). A part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be connected via a bus or the like.

In a case where a part or all of each component of each device is achieved by a plurality of computers, circuits, and the like, the plurality of computers, circuits, and the like may be disposed in a centralized manner or in a distributed manner.

The control method described in the example embodiments may be achieved by being executed by a computer such as the control systems 10 and 20.

Each program such as a program for formulization or a program for optimization described in the example embodiments is recorded in a computer-readable recording medium such as an HDD, an SSD, a flexible disk, an optical disk, a magnetic optical disk, or a USB memory. Each program is read from the recording medium by the computer to be executed. Each program may be distributed via the communication network NT.

The functions of each component of the control system 10 and each component of the control system 20 described above may be achieved by dedicated hardware such as a computer. Alternatively, each component may be achieved by software. Alternatively, each component may be achieved by a combination of hardware and software.

While the present disclosure has been particularly shown and described with reference to example embodiments thereof, the present disclosure is not limited to these example embodiments. It will be grasped by those of ordinary skill in the art that various changes in form and details may be made therein without departing from the spirit and scope of the present disclosure as defined by claims. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, in a case where the example embodiments are implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A control system including:
output means for outputting an avatar of a provider who provides a service to a user of the service in a virtual reality space and an action of the avatar to a display device of the user;
acquisition means for acquiring an action history of the user who is using the service; and
determination means for determining at least one of the avatar of the provider of the service and the action of the avatar in the virtual reality space, based on the action history of the user, in which
the output means switches at least one of the avatar and the action of the provider of the service to at least one of the determined avatar and action of the provider and outputs at least one of the determined avatar and action.

### (Supplementary Note 2)

The control system according to supplementary note 1, in which
in a case where there is a plurality of the users, the determination means determines at least one of an avatar and an action visible to each of the plurality of users, based on the action history of each of the plurality of users, and
the output means outputs at least one of the avatar and the action of the user determined for each of the plurality of users.

### (Supplementary Note 3)

The control system according to supplementary note 1 or 2, in which
in a case where there is the plurality of users, the determination means determines at least one of the avatar of the provider and the action of the avatar visible to each of the plurality of users, based on the action history of each of the plurality of users, and
the output means performs switching to and outputs at least one of the avatar and the action of the provider determined for each of the plurality of users.

### (Supplementary Note 4)

The control system according to any one of supplementary notes 1 to 3, in which
the action history is a degree of attentive listening of the user in a conversation with the provider.

### (Supplementary Note 5)

The control system according to any one of supplementary notes 1 to 4, in which

the action history is biometric information of the user.

### (Supplementary Note 6)

The control system according to supplementary note 5, in which the determination means determines at least one of the avatar of the provider of the service and the action of the avatar in the virtual reality space, based on at least one of an emotion of the user, a tension degree of the user, and a fatigue degree of the user estimated from the biometric information of the user.

### (Supplementary Note 7)

The control system according to any one of supplementary notes 1 to 6, in which
the acquisition means acquires a past action history of the user,
the determination means determines the avatar of the provider of
the service, based on the past action history of the user, before start of the service, and
the output means outputs the determined avatar of the provider.

### (Supplementary Note 8)

The control system according to any one of supplementary notes 1 to 7, in which
the output means outputs an avatar and an action of the user in the virtual reality space to a display device of the provider,
the determination means determines at least one of the avatar and the action of the user, based on the action history of the user, and
the output means switches at least one of the avatar and the action of the user to at least one of the determined avatar and action of the user and outputs at least one of the determined avatar and action.

### (Supplementary Note 9)

The control system according to any one of supplementary notes 1 to 8, in which
the output means outputs the avatar and the action of the user in the virtual reality space to the display device of the provider,
the acquisition means acquires an action history of the provider who is providing the service,
the determination means further determines at least one of the avatar and the action of the user, based on the action history of the provider, and
the output means switches at least one of the avatar and the action of the user to at least one of the determined avatar and action of the user and outputs at least one of the determined avatar and action of the user.

### (Supplementary Note 10)

The control system according to any one of supplementary notes 1 to 9, in which
the acquisition means further acquires the action history of the provider who is providing the service,
the determination means determines the avatar and the action of the provider, based on the action history of the provider and the action history of the user, and
the output means switches at least one of the avatar and the action of the provider to at least one of the determined avatar and action of the provider and outputs at least one of the determined avatar and action.

### (Supplementary Note 11)

The control system according to any one of supplementary notes 1 to 10, in which
the determination means determines at least one of any one avatar and any one action, from a plurality of avatars and a plurality of actions.

### (Supplementary Note 12)

The control system according to any one of supplementary notes 1 to 11, in which
the determination means inputs the acquired action history of the user into a model that has learned a relationship between the action history of the user and the avatar of the provider and the action of the avatar, based on past action histories of the plurality of users and the avatar of the provider and the action of the avatar at the time when each of the plurality of users uses the service and determines at least one of the avatar and the action of the provider of the service.

### (Supplementary Note 13)

The control system according to supplementary note 12, further including:
learning means for generating the model that has learned the relationship between the action history of the user and the avatar of the provider and the action of the avatar, based on the past action histories of the plurality of users and the avatar of the provider and the action of the avatar at the time when each of the plurality of users uses the service, in which
the determination means inputs the acquired action history of the user into the generated model and determines at least one of the avatar and the action of the provider of the service.

### (Supplementary Note 14)

The control system according to any one of supplementary notes 1 to 13, in which
the determination means determines at least one of an avatar of a provider different from the provider who is providing the service to the user and an action of the avatar.

### (Supplementary Note 15)

The control system according to any one of supplementary notes 1 to 13, in which
the determination means determines at least one of an avatar of the provider same as the provider who is providing the service to the user and an action of the avatar.

### (Supplementary Note 16)

The control system according to any one of supplementary notes 1 to 15, further including:
reception means for receiving a switching instruction of an avatar from the provider, in which
upon receiving the switching instruction, the output means switches at least one of the avatar and the action of the provider to at least one of the determined avatar and action of the provider and outputs at least one of the determined avatar and action.

### (Supplementary Note 17)

The control system according to any one of supplementary notes 1 to 15, further including:
reception means for receiving a switching instruction of an avatar from the user, in which
upon receiving the switching instruction, the output means switches at least one of the avatar and the action of the provider to at least one of the determined avatar and action of the provider and outputs at least one of the determined avatar and action.

### (Supplementary Note 18)

The control system according to any one of supplementary notes 1 to 17, in which
the determination means further determines a sound effect, and
the output means outputs the determined sound effect.

### (Supplementary Note 19)

The control system according to any one of supplementary notes 1 to 18, in which
the user is a customer, and
the provider is a clerk.

### Supplementary Note 20)

The control system according to supplementary note 19, in which
the action history includes a purchase history and a purchasing scene of the user in the purchase history,
the determination means determines a purchasing scene by another user, based on a purchasing scene at the time when a product is purchased in the past in the purchase history, and
the output means outputs the determined purchasing scene.

### (Supplementary Note 21)

The control system according to any one of supplementary notes 1 to 18, in which
the user is a patient, and
the provider is a doctor.

### (Supplementary Note 22)

The control system according to supplementary note 21, in which
the determination means determines the number of other patients visible to the user, based on the action history, and
the output means outputs avatars of the determined number of other patients.

### (Supplementary Note 23)

A control method in which a computer performs processing including:
outputting an avatar of a provider who provides a service to a user of the service in a virtual reality space and an action of the avatar to a display device of the user;
acquiring an action history of the user who is using the service; and
determining at least one of the avatar of the provider of the service and the action of the avatar in the virtual reality space, based on the action history of the user, in which
in the outputting processing, at least one of the avatar and the action of the provider of the service is switched to at least one of the determined avatar and action of the provider, and at least one of the determined avatar and action is output.

### (Supplementary Note 24)

A non-transitory computer-readable recording medium recording a program for causing a computer to execute processing including:
outputting an avatar of a provider who provides a service to a user of the service in a virtual reality space and an action of the avatar to a display device of the user;
acquiring an action history of the user who is using the service; and
determining at least one of the avatar of the provider of the service and the action of the avatar in the virtual reality space, based on the action history of the user, in which
in the outputting processing, at least one of the avatar and the action of the provider of the service is switched to at least one of the determined avatar and action of the provider, and at least one of the determined avatar and action is output.

### (Supplementary Note 25)

A program for causing a computer to execute processing including:
outputting an avatar of a provider who provides a service to a user of the service in a virtual reality space and an action of the avatar to a display device of the user;
acquiring an action history of the user who is using the service; and
determining at least one of the avatar of the provider of the service and the action of the avatar in the virtual reality space, based on the action history of the user, in which
in the outputting processing, at least one of the avatar and the action of the provider of the service is switched to at least one of the determined avatar and action of the provider, and at least one of the determined avatar and action is output.

### REFERENCE SIGNS LIST

10, 20 control system
21 display device
80 computer
101, 201 output unit
102, 202 acquisition unit
103, 203 determination unit
204 reception unit
205 learning unit
801 processor
802 ROM
803 RAM
804 storage device
805 communication interface
806 input/output interface
807 bus
NT communication network

What is claimed is:

1. A control system comprising:
one or more memories storing instructions; and
one or more processors configured to execute the instructions to:
output an avatar of a provider who provides a service to a user of the service in a virtual reality space and an action of the avatar to a display device of the user;
acquire an action history of the user who is using the service;
determine at least one of the avatar of the provider of the service and the action of the avatar in the virtual reality space, based on the action history of the user; and switch at least one of the avatar and the action of the provider of the service to at least one of the determined avatar and action of the provider and outputs at least one of the determined avatar and action.

2. The control system according to claim 1, wherein the one or more processors are further configured to execute the instructions to:
in a case where there is a plurality of the users, determine at least one of an avatar and an action visible to each of the plurality of users, based on the action history of each of the plurality of users, and
output at least one of the avatar and the action of the user determined for each of the plurality of users.

3. The control system according to claim 1, wherein the one or more processors are further configured to execute the instructions to:
in a case where there is the plurality of users, determine at least one of the avatar of the provider and the action of the avatar visible to each of the plurality of users, based on the action history of each of the plurality of users, and
perform switching to and outputs at least one of the avatar and the action of the provider determined for each of the plurality of users.

4. The control system according to claim 1, wherein the action history is a degree of attentive listening of the user in a conversation with the provider.

5. The control system according to claim 1, wherein
the action history is biometric information of the user.

6. The control system according to claim 5, wherein the one or more processors are further configured to execute the instructions to:
determine at least one of the avatar of the provider of the service and the action of the avatar in the virtual reality space, based on at least one of an emotion of the user, a tension degree of the user, and a fatigue degree of the user estimated from the biometric information of the user.

7. The control system according to claim 1, wherein the one or more processors are further configured to execute the instructions to:
acquire a past action history of the user;
determine the avatar of the provider of the service, based on the past action history of the user, before start of the service; and
output the determined avatar of the provider.

8. The control system according to claim 1, wherein the one or more processors are further configured to execute the instructions to:
output an avatar and an action of the user in the virtual reality space to a display device of the provider,
determine at least one of the avatar and the action of the user, based on the action history of the user, and
switch at least one of the avatar and the action of the user to at least one of the determined avatar and action of the user and outputs output at least one of the determined avatar and action.

9. The control system according to claim 1, wherein the one or more processors are further configured to execute the instructions to:
output the avatar and the action of the user in the virtual reality space to the display device of the provider,
acquire an action history of the provider who is providing the service,
determine at least one of the avatar and the action of the user, based on the action history of the provider; and
switch at least one of the avatar and the action of the user to at least one of the determined avatar and action of the user and output at least one of the determined avatar and action of the user.

10. The control system according to claim 1, wherein the one or more processors are further configured to execute the instructions to:
acquire the action history of the provider who is providing the service;
determine the avatar and the action of the provider, based on the action history of the provider and the action history of the user; and
the switch at least one of the avatar and the action of the provider to at least one of the determined avatar and action of the provider and output at least one of the determined avatar and action.

11. The control system according to claim 1, wherein the one or more processors are further configured to execute the instructions to:
determine at least one of any one avatar and any one action, from a plurality of avatars and a plurality of actions.

12. The control system according to claim 1, wherein the one or more processors are further configured to execute the instructions to:
input the acquired action history of the user into a model that has learned a relationship between the action history of the user and the avatar of the provider and the action of the avatar, based on past action histories of the plurality of users and the avatar of the provider and the action of the avatar at the time in a case where each of the plurality of users uses the service and determine at least one of the avatar and the action of the provider of the service.

13. The control system according to claim 12, wherein the one or more processors are further configured to execute the instructions to:
generate the model that has learned the relationship between the action history of the user and the avatar of the provider and the action of the avatar, based on the past action histories of the plurality of users and the avatar of the provider and the action of the avatar at the time when each of the plurality of users uses the service; and
input the acquired action history of the user into the generated model and determine at least one of the avatar and the action of the provider of the service.

14. The control system according to claim 1, wherein the one or more processors are further configured to execute the instructions to:
determine at least one of an avatar of a provider different from the provider who is providing the service to the user and an action of the avatar.

15. The control system according to claim 1, wherein the one or more processors are further configured to execute the instructions to:
determine at least one of an avatar of the provider same as the provider who is providing the service to the user and an action of the avatar.

16. The control system according to claim 1, wherein the one or more processors are further configured to execute the instructions to:
receive a switching instruction of an avatar from the provider; and
upon receiving the switching instruction, switch at least one of the avatar and the action of the provider to at least one of the determined avatar and action of the provider and output at least one of the determined avatar and action.

17. The control system according to claim 1, wherein the one or more processors are further configured to execute the instructions to:
receive a switching instruction of an avatar from the user; and
upon receiving the switching instruction, switch at least one of the avatar and the action of the provider to at least one of the determined avatar and action of the provider and output at least one of the determined avatar and action.

18. The control system according to claim 5, wherein the one or more processors are further configured to execute the instructions to:
determine a sound effect according to a state of the user estimated from the biometric information of the user; and
output the determined sound effect.

19-22. (canceled)

23. A control method in which a computer performs processing comprising:
outputting an avatar of a provider who provides a service to a user of the service in a virtual reality space and an action of the avatar to a display device of the user;
acquiring an action history of the user who is using the service; and
determining at least one of the avatar of the provider of the service and the action of the avatar in the virtual reality space, based on the action history of the user, wherein in the outputting processing, at least one of the avatar and the action of the provider of the service is switched to at least one of the determined avatar and action of the provider, and at least one of the determined avatar and action is output.

24. A non-transitory computer-readable recording medium recording a program for causing a computer to execute processing comprising:
outputting an avatar of a provider who provides a service to a user of the service in a virtual reality space and an action of the avatar to a display device of the user;
acquiring an action history of the user who is using the service; and
determining at least one of the avatar of the provider of the service and the action of the avatar in the virtual reality space, based on the action history of the user, wherein
in the outputting processing, at least one of the avatar and the action of the provider of the service is switched to at least one of the determined avatar and action of the provider, and at least one of the determined avatar and action is output.
